(19) United States
(12) Patent Application Publication
(10) Pub. No.: US 2006/0076775 A1
(43) Pub. Date: Apr. 13, 2006

(54) Pipe for lining passages

(76) Inventors: James D. Caldwell, Greenville, NC (US); Lynn E. Osborn, Wildwood, MO (US)

Correspondence Address: HUSCH & EPPENBERGER, LLC, 190 CARONDELET PLAZA, SUITE 600, ST. LOUIS, MO, 63105-3441, US

(21) Appl. No.: 10/964,432

(22) Filed: Oct. 13, 2004

(51) Int. Cl. F16L 17/00

(52) U.S. Cl. 285/374

(57) ABSTRACT

A pipe for lining a passage includes at least a first pipe section having a bell at one end and at least a second pipe section having a spigot at one end, adapted to mate with the bell of the first pipe section. The pipe sections are closed molded to form the final geometry of the bell and spigot. At least one of the bell of the first pipe section or the spigot of the second pipe section has a circumferential groove molded therein to substantially its final shape. An elastomeric gasket sized to fit in the groove forms a compression seal between the first pipe section and the second pipe section.

### CROSS-REFERENCE TO RELATED APPLICATIONS

None.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

This invention relates to the lining of sewers, water mains, culverts, tunnels, conduits, pipes, and other passageways (generically referred to herein as passages), and especially but not exclusively to the lining of underground passages. Lining in this context is intended to include both rehabilitation and using the pipe of the present invention as new pipe for burial. It is anticipated that the process is particularly suited for rehabilitation, including the relining of sewers. It is more particularly directed to slipline pipe for passages.

As sewers and other passages age, they deteriorate in many ways. Cracks appear and joints separate. Infiltration through these cracks and joints creates external voids, accelerates structural deterioration and can overload collection systems and treatment plants. Many passages can be successfully rehabilitated using what is called the soft-lining or cured in place method. This method is illustrated in U.S. Pat. Nos. 4,009,063 and 4,064,211. Most deteriorating sewers can be rehabilitated economically in this way.

Other rehabilitation projects, particularly those involving larger passages, may require a different method, one using a hard liner inside the existing passage. Inserting a hard liner in an existing passage poses several problems. Typically, there is a limited amount of space available in such passages, so manipulating the liner to place it in the passage and/or assemble it in place can be difficult. Moreover, the lining of such passages should not excessively reduce the cross-sectional area of the passage, since otherwise the flow rate through the passage will be unduly restricted.

One known manner of inserting a hard liner inside an existing passage is called sliplining. In this type of remediation, a new liner pipe is pushed or pulled into the existing pipe, creating a slight decrease in the inside diameter of the pipe. Sliplining is normally used with pipes ranging from 8 to 96 inches in diameter. Sliplining can be performed rapidly, without disturbing adjacent services or requiring bypass pumping. It makes it possible to repair long lengths of pipe with minimal disruption. Because the liner is structurally sound, it solves problems relating to leakage and structural deterioration.

It is known that sections of slipline pipe may be joined together with an elastomeric gasket therebetween to form a seal between the sections of the pipe. For example, U.S. Pat. No. 6,176,523 shows such a pipe with a gasket 80 disposed in a recess 66 for creating a seal between two sections of pipe. This involves considerable handling and machining of the pipe, however, since the recess (and in fact the various shaped surfaces of the ends of the pipe sections) are formed by sawing, routing, lathing, or the like. See col. 5, lines 24-31, for example. These machine steps are expensive, and can result in damage to the pipe sections. U.S. Pat. No. 5,547,230 shows a similar system.

Similar pipe sections are made by winding a construction material, such as polyethylene, around suitably sized mandrels. See U.S. Pat. No. 5,261,461, particularly FIG. 2B, for the types of shapes (with recesses for gaskets) that can be formed in this manner. The structure shown in FIGS. 2A and 2B are known as a bell and spigot design, the bell being the portion of pipe that accepts the smaller diameter spigot. A similar process uses fiberglass strands wound around a mandrel. Centrifugal casting and rotational casting are also used.

Various connectors have been proposed for pipe sections for slipline pipe. For a particularly complicated one see U.S. Pat. No. 6,113,158.

In the following application, the process is described in connection with sliplining, but it should be understood that the present process is not limited to sliplining or slipline pipe. Sliplining, as a process, is not limited to passages that are circular in cross section. Such passages can be oval, elliptical, circular, or any modification of these shapes. Sliplining is equally applicable to those passages. See U.S. Pat. No. 5,458,155 which discloses (see FIGS. 3A-3F) modifying a circular pipe through sawing and the addition of a floor panel 42 to form such shapes.

The slipline pipe discussed above could be improved. It would be desirable to have a simple, gasketed joint between pipe sections that does not require expensive machining steps. The gasketed joints provide a tight joint between pipe sections that can accommodate some deflection of the pipe sections. But forming complicated shapes or machining the final product raises the cost substantially.

It would also be desirable to have the pipe sections formed as single sections, rather than multi-part sections as shown in U.S. Pat. No. 5,458,155 above. Multi-part sections are more expensive to fabricate. This is particularly true in connection with non-circular pipes.

Finally, it would be desirable to avoid the external and internal mandrel methods of construction, because of the inherent variation in product produced in that way.

### SUMMARY OF THE INVENTION

Among the various objects and features of the present invention is the provision of an improved pipe.

Another object is the provision of such a pipe that facilitates the placement and assembly of the pipe in a passage.

A third object is the provision of such a pipe that is closed molded to its substantially final shape.

A fourth object is the provision of such a pipe that may be formed in non-circular shapes if desired.

A fifth object is the provision of such a method that it is relatively simple and inexpensive.

Other objects and features will be in part apparent and in part pointed out hereinafter.

In one aspect of the present invention, a pipe for lining a pre-existing passage includes at least a first pipe section having a bell at one end and at least a second pipe section having a spigot at one end. The spigot is adapted to mate with the bell of the first pipe section. The first and second pipe sections are both closed molded. At least one of the bell of the first pipe section or the spigot of the second pipe section has a circumferential groove molded therein to substantially its final shape. An elastomeric gasket sized to fit in said groove forms a compression seal between the first pipe section and the second pipe section.

In a second aspect of the present invention, a pipe section for a pipe includes a pipe body having a groove closed molded therein at one end of the pipe body, the pipe body having one end that is closed molded to have a predetermined outer size and a second end that is closed molded to have a predetermined inner size, the inner size of the second end being larger than the outer size of the first end, the pipe body having an inner size, except at said second end, that is less than the outer size of the first end.

### BRIEF DESCRIPTION OF THE DRAWINGS

FIG. 1 is a cross-sectional view of pipe of the present invention;

FIG. 2 is an enlarged view of a portion of FIG. 1;

FIG. 3 is a cross-sectional view illustrating one possible transverse cross-sectional shape of the pipe of the present invention.

Similar reference characters indicate similar parts throughout the several views of the drawings.

### DESCRIPTION OF THE PREFERRED EMBODIMENT

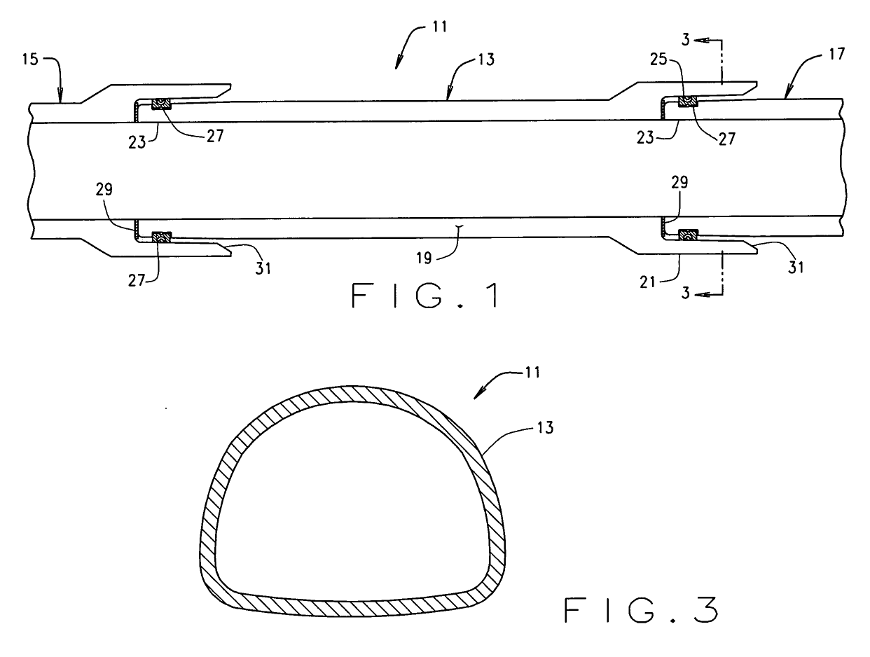

Turning to the drawings, FIG. 1 illustrates a cross section of portion of a pipe 11 of the present invention. Although described in terms of a slipline pipe, it should be understood that the present invention is also applicable to other pipes for lining passages.

Specifically, FIG. 1 shows one complete pipe section 13 and two adjacent partial sections 15, 17. In the simplest form of the invention all the pipe sections are identical. Pipe section 13 includes a pipe body 19 terminating at one end in a bell 21 and at the other end in a spigot 23.

As can be seen, bell 21 has an inner size large enough to accept the corresponding spigot of the next section of pipe, in this case section 17. (In the case of circular pipe, the inner size corresponds to the inner diameter of the pipe. In the case of non-circular pipe, the inner size corresponds to the various dimensions of the opening inside the pipe.) An elastomeric gasket 25 is disposed in a groove 27 of each spigot 23, so as to form a seal between the pipe sections. Gasket 25 may be made in accordance with U.S. Pat. No. 6,719,302, although the actual gasket used is not a feature of the present invention. Groove 27 extends circumferentially around its corresponding spigot, so that the gasket disposed therein can provide a suitable seal around the periphery of each pipe section. The use of an elastomeric gasket also allows for some misalignment between the pipe sections. Optionally, some compression packing 29 (of any suitable material) may be disposed between the pipe sections as shown. The compression packing also extends around the circumference of the pipe. As can be seen in FIG. 1, each bell has a slight taper or chamfer 31 at its end to promote the lead in of the gasket 25 on the spigot 23 into the corresponding bell 21. If desired to accommodate deflection between the pipe sections, the walls of spigot 23 and/or bell 21 may have a draft. A draft of one degree for each is shown in the drawings. The present invention does not require any draft, however, in either the bell or the spigot.

It is preferred that the pipe sections be closed molded to substantially their final dimensions, including the groove 27 and the chamfer 31, to eliminate or at least drastically reduce the necessity of any machining of the pipe sections. A suitable closed molding process is disclosed in co-assigned U.S. patent application Ser. No. 10/364,096, the disclosure of which is incorporated herein by reference. The molding process is called “closed” to distinguish the open molding process in which material is sprayed upon the interior or exterior of a mandrel, or similar processes.

The closed molding process may involve a mold with one or more openings to allow the injection or other insertion of material, and the escape of gases, but the final shape of the molded object, in this case the sections of slipline pipe, is determined by the interior and exterior shape of the mold. It is of particular importance that the circumferential groove 27 be closed molded in the pipe sections to substantially its final shape. This greatly reduces cost and eliminates the possibility of subsequent damage to the spigot during machining which would otherwise be required to create the groove.

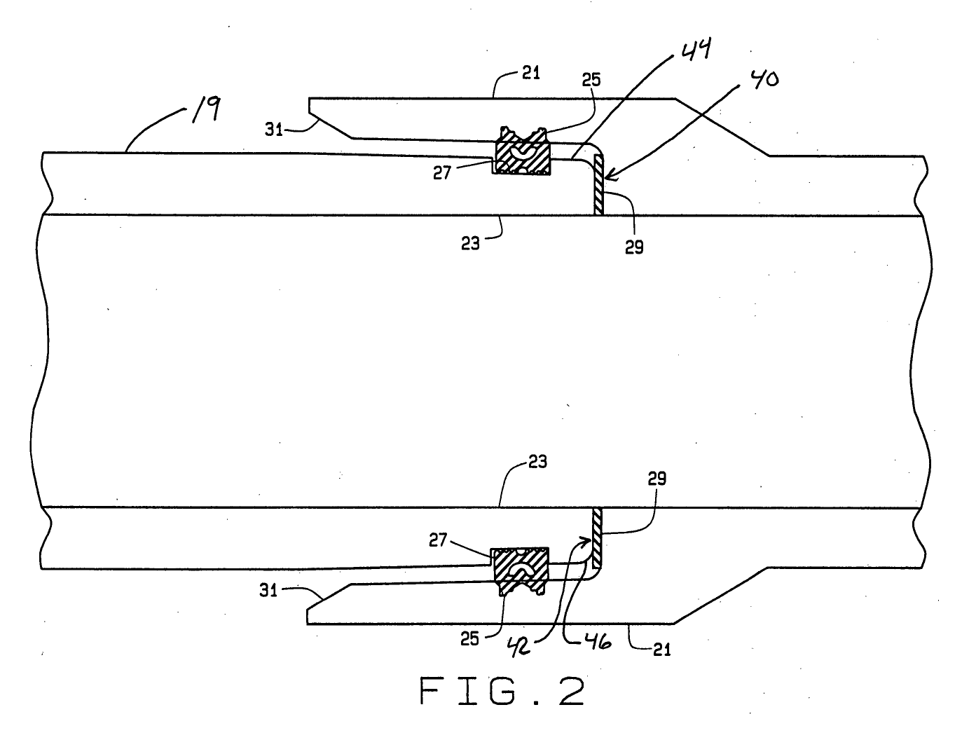

FIG. 2 is a larger view of the bell and spigot arrangement of the pipe sections. Gasket 25 in this view is shown uncompressed (its uncompressed height exceeding the distance between the spigot 23 and the bell 21) to illustrate the relative size of the uncompressed gasket 25 with respect to the space available between the spigot 23 and the bell 21. When assembled, of course, the gasket 25 is compressed to fit in the space available between the spigot and the bell by the force exerted by the pipe sections.

Although the slipline pipe of the present invention may have any cross-section, it should be realized that such pipe formed in a closed mold process is especially well suited for non-circular shapes such as that shown in FIG. 3. Oval, elliptical, circular, or any modification of these shapes are easily obtainable using the closed mold process.

The pipe of the present invention may be used for any application for lining passages. Sizes of eight inches to 96 inches would be conventional. The pipe sections themselves may be many feet in length, limited primarily by the restrictions imposed by shipping or by the passage being lined.

In view of the above, it will be seen that all the objects and features of the present invention are achieved, and other advantageous results obtained. The description of the invention contained herein is illustrative only, and is not intended in a limiting sense.

1. A pipe for lining a pre-existing passage comprising:
at least a first pipe section having a bell at one end, the bell having a planar end wall;
at least a second pipe section having a pipe body and a spigot at one end, the spigot having a terminal end portion and a planar end wall, the terminal end portion having the same shape and approximate size as the pipe body, the spigot adapted to mate with the bell of the first pipe section;
said first and second pipe sections both being closed molded;
the first and second pipe sections each having a non-circular cross-section taken perpendicular to the longitudinal axis of the pipe;
at least one of the bell of the first pipe section or the spigot of the second pipe section having a groove molded therein to substantially its final shape, the groove being spaced apart from the spigot end wall; and
an elastomeric gasket sized to fit in said groove to form a compression seal between the first pipe section and the second pipe section.

2. The pipe as set forth in claim 1 wherein a plurality of pipe sections each have a bell at one end and a spigot at the opposite end.

3. The pipe as set forth in claim 1 wherein the groove is molded in the spigot.

4. The pipe as set forth in claim 1 wherein substantially all the dimensions of the pipe sections are formed in a closed mold.

5. (canceled)

6. The pipe as set forth in claim 1 wherein the distal end of the bell is chamfered, said chamfer being formed therein in a closed mold process.

7. The pipe as set forth in claim 1 wherein at least one of the bell and spigot have a draft therein, formed in a closed mold process.

8. The pipe as set forth in claim 1 wherein the pipe sections are coupled together without an external coupler.

9. The pipe as set forth in claim 1 wherein the bell is unmachined.

10. The pipe as set forth in claim 1 wherein the spigot is unmachined.

11. The pipe as set forth in claim 1 wherein the groove is unmachined.

12. The pipe as set forth in claim 1 wherein the outer size of the spigot is less than the inner size of the bell to accommodate misalignment of pipe sections, said gasket having a height greater than the gap between the outer surface of the spigot and the inner surface of the bell, such that the gasket in the molded groove forms a compression seal between the bell and the spigot.

13. The pipe as set forth in claim 1 wherein the pipe has an internal size of at least eight inches.

14. The pipe as set forth in claim 13 wherein the pipe is non-circular and has an inner dimension measured along a minor axis of at least twenty-four inches.

15. A pipe section for a liner pipe, the pipe section having a non-circular cross-section taken perpendicular to its longitudinal axis, the pipe section comprising:
a pipe body having a planar end wall and a groove closed molded therein at one end of the pipe body, said pipe body having one end that is closed molded to have an outer size and a second end that is closed molded to have an inner size, the inner size of the second end being greater than the outer size of the first end, said pipe body having an inner size, except at said second end, that is less than the outer size of the first end; and a terminal end portion located intermediate the planar end wall and the groove, the terminal end portion having substantially the same shape and approximate size as the pipe body.

16. The pipe section as set forth in claim 15 wherein the pipe section is closed molded to its final dimensions.

17. The pipe section as set forth in claim 15 wherein the inner sizes are measured along a minor axis.

18. A pipe for lining a pre-existing passage comprising:
at least a first pipe section having a bell at one end, the bell having a planar end wall;
at least a second pipe section having a pipe body and a spigot at one end, the spigot having a terminal end portion and a planar end wall, the terminal end portion having the same shape and approximate size as the pipe body, the spigot adapted to mate with the bell of the first pipe section;
a compression packing disposed between the first pipe section and the second pipe section;
at least one of the bell of the first pipe section or the spigot of the second pipe section having a circumferential groove molded therein to substantially its final shape, the circumferential groove being spaced apart from the spigot end wall; and
an elastomeric gasket sized to fit in said circumferential groove to form a compression seal between the first pipe section and the second pipe section.

19. The pipe as set forth in claim 18 wherein the first and second pipe sections each have a non-circular cross-section taken perpendicular to the longitudinal axis of the pipe.

20. The pipe as set forth in claim 18 wherein substantially all the dimensions of the pipe sections are formed in a closed mold.
